(19) United States
(12) Patent Application Publication
(10) Pub. No.: US 2003/0150841 A1
(43) Pub. Date: Aug. 14, 2003

(54) Electric circuit breaker, as well as plant, use and method where such is used

(76) Inventors: Freddy Magnussen, Vasteras (SE); Philip Kjaer, Vasteras (SE); Stefan Valdemarsson, Lidkoping (SE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/221,197

(22) PCT Filed: Mar. 23, 2001
(86) PCT No.: PCT/SE01/00636

(30) Foreign Application Priority Data
Mar. 23, 2000 (SE) 0001032-2

(51) Int. Cl. H01H 33/66

(52) U.S. Cl. 218/118

(57) ABSTRACT

The invention relates to an electric circuit breaker. The circuit breaker comprises at least one mobile contact with operating means (2) for operating the same. An electric motor (6) is arranged for driving the operating means (2). The motor (6) is powered from a current source (50) via a current converter (40). According to the invention, the motor (6) and/or current converter (40) are greatly under-dimensioned in relation to the output the current converter is designed to deliver. This is possible because the operating duration is so brief. Under-dimensioning results in extensive cost-savings. The invention also relates to an electric plant equipped with such a circuit breaker. The invention further relates to the use of such a circuit breaker and a method for breaking electric current in the corresponding fashion.

### FIELD OF INVENTION

According to a first aspect, the present invention relates to an electric circuit breaker of the kind set forth in the preamble to claim 1. The circuit breaker is accordingly driven by an electric motor. A current converter is connected between the motor and the current source supplying power to the motor. The second, third and fourth aspects of the invention relate to an electric plant equipped with such a circuit breaker, to the use of such an electric circuit breaker and to a method for breaking an electric current.

Circuit breakers of this kind are used in electric plants, such as switching stations, for breaking the power when necessary. A circuit breaker must be able to break and close normal power loads, but it must in particular be capable of rapidly breaking the short-circuit current arising when a fault occurs in the system. A circuit breaker's main components are the breaker chamber and the system for operating the same. Breaking and closing the current is achieved through contacts in the breaker chamber in which one is normally stationary and the other is mobile. The mobile contact is brought into contact with/separated from the stationary contact with the operating means. The present invention primarily relates to the system for operating the mobile contact, said system comprising operating means, a motor, a source of power and a rectifier. The actual breaker function, i.e. the design of the breaker chamber, can be implemented in different ways, e.g. vacuum breakers, SF₆ breakers or oil-poor breakers. The circuit breaker according to the invention is primarily intended for medium and high-voltage, i.e. from about 1 kV up to several hundred kV.

### DESCRIPTION OF THE BACKGROUND ART

Control means for a circuit breaker traditionally employ breaking and closing springs storing enough energy for the breaking and closing operations. Triggering can be automatic or by manual action. The function of the closing spring is to close the switch and tension the releasing spring. The releasing spring operates in breaking. The closing spring is tensioned by an electric motor.

However, a spring-operated breaker has a number of disadvantages. The movement of the mobile contact is entirely governed by the mechanical characteristics of the springs and movement-transfer mechanism. The movement pattern of the mobile contact cannot be changed by the user, as it is predetermined by the device's design. This means that the mobile contact follows a pre-determined movement profile when the closing spring or the releasing spring is triggered. Moreover, the amount of energy transferred to the mobile contact by the operating means during operation is fixed once and for all. So the movement of the mobile contact cannot be tailored to the kind of opening or closing required in individual instances. Nor can the movement's speed or acceleration be controlled.

The use of a spring-loaded operating device also incorporates poor precision, as the device is made of a relatively large number of components. As a result of the large number of components, initial adjustment of the operating means, a complex and time-consuming procedure, is also necessary. The poor precision in positioning the mobile contact and the absence of any facility for controlling the movement even means that damping devices may be needed at the end of the opening or closing process in order to prevent uncontrolled mechanical jarring. Another disadvantage is the high noise level of a spring-loaded operating device. This may necessitate the use of acoustical insulation for the operating device's housing. The large number of components in a spring-loaded operating device means that periodic service is required to maintain the device's operation and to compensate for variations in the mobile contact caused by wear and ageing. Finally, a spring-loaded operating device has a relatively long delay from the time an operating command is issued until the mobile contact starts moving.

A hydraulic operating means, in which the movements of the mobile contact are achieved with hydraulics, is also previously known. This type of means eliminates some of the disadvantages associated with a spring-loaded breaker. However, a hydraulic operating means has other disadvantages due to the presence of hydraulic fluid. The fluid's viscosity is often temperature-related, a circumstance affecting function and the movement profile. There is also a risk of hydraulic fluid leaking into the surroundings. Hydraulically operated circuit breakers also have the problems of loud noise and a need for periodic service.

Electromagnetically operated circuit breakers are previously known. The operating force in electromagnetic operating means is achieved either by the use of Lorentz force or by interacting fields from electromagnets. The Lorentz force is the force acting on a current-carrying conductor when the conductor is placed in a magnetic field. The principle is applied e.g. in a speaker coil, and the use of this force for operating means for circuit breakers, as in vacuum breakers, is previously known. One such speaker coil is described in PCT/US96/07114. However, a major disadvantage of such a coil is that its stroke length is relatively short. The use of such a coil for breaker operation is therefore limited to circuit breakers with a short stroke.

A magnetic operating device uses a plurality of electromagnets for operating the mobile contact in a circuit breaker. The operating principle is that an electromagnet, connected to the mobile contact, moves between two end positions, whereupon an air gap in a magnetic circuit is closed or widened. One example of such a device is taught in PCT/SE96/01341. The mobile contact in the known device is connected to a rotor equipped with a plurality of symmetrically arranged iron armatures. The rotating device is arranged in an outer, stationary iron core. The latter is equipped with coils. When current is fed to these coils, the rotor rotates between two end positions at which the armature's electromagnetic pole surfaces come into contact with the iron core's. When there is a rotary movement, one arm on each armature moves into each coil so an air gap between pole surfaces is closed or widened. The air gap must be large to achieve a stroke of sufficient length. Since a large air gap makes a heavy demand on magnetic energy, a great deal of energy is required for driving the electromagnetic operating device. The time delay will be considerable, as a large air gap must also be magnetised. As in other operating means utilising a speaker coil, the stroke length is limited.

The energy the operating means delivers to the mobile contact corresponds to the operating force times the stroke length or, in rotating operating means, torque times the angular movement. In known electromagnetic operating means, the stroke length, or rotary movement, is limited in advance, as the movement has end positions. In order to deliver sufficient energy to the mobile contact, the force per movement must be very great. As a result, the known electromagnetic operating means are relatively large, bulky and expensive. This is especially true when high energy is required for the mobile contact movement, as is the case when the breaker is used for high voltage.

Finally, devising a circuit breaker operated by means of a rotating electric motor is previously known. Such breakers are described in e.g. U.S. Pat. No. 4,913,380, EP 0 772 214 and WO 00/36621.

### DISCLOSURE OF THE INVENTION

The sequence of events in the operation of a breaker, i.e. breaking a circuit to interrupt the current or closing a circuit to switch on current, is very brief. When a circuit is broken, the operating movement lasts on the order of 40-60 ms. A somewhat longer operating duration is permissible when a circuit is closed. Operation requires a relatively large amount of power. The motor must therefore supply a high output for a brief period of time. The cost of the electric motor and the current converter arranged between the motor and the source supplying power to the motor normally increases as the size of these components increases. However, limiting the cost of these components is an important factor in achieving a competitively priced circuit breaker driven by an electric motor. Keeping these costs sufficiently low can be a problem with a motor and current converter whose rated specifications are on a par with operating requirements. The motor would also be too large to accelerate the mass of the motor fast enough in the short time available.

In view of this, the objective of the present invention is to try to master the aforementioned problem. According to a first aspect of the invention, this is achieved by an electric circuit breaker of the kind defined in the preamble to claim 1 and having the special features set forth in the claim's characterising clause.

When the motor and/or current converter are greatly under-dimensioned, the size, and hence the cost, of these components will be considerably less than if they were dimensioned with rated specifications corresponding to the power required at the moment a circuit is broken or closed. The cost of the energy bank would also be greatly reduced if the current converter were heavily overloaded. Since the rectifier delivers a higher current to the motor, the number of motor winding turns can be reduced, thereby reducing voltage requirements. The capacity of the capacitors in the power source can accordingly be charged to a lower voltage. The energy bank can be made smaller and, therefore, cheaper when a larger energy withdrawal is made from the capacitors.

This under-dimensioning is possible because the motor only operates for an extremely brief period of time. The generation of heat in each component usually imposes a limit on the load it can tolerate, and its nominal rated output is set for the heat accumulating in continuous operation over a long period of time. With an operating time of the order of about twenty up to a few hundred ms, no large amount of heat can develop. In the applications for which they were designed, the motor and/or the current converter can therefore be subjected to currents imposing a load greatly exceeding their respective rated specifications. In the present application, ‘rated specifications’, such as rated output and torque at the rated load, refer to the rated specifications of a conventional version of a corresponding motor with respect to heat removal. Thus, ‘rated specifications’ relate to a motor in which the generated heat is removed in the normal manner and to the normal degree, i.e. with a normal enclosure without any special insulation or enhanced heat dissipation means.

According to a preferred embodiment, the electric motor is a rotating electric motor. Since other kinds of electric motors, such as linear motors, are possible within the scope of the inventive concept, a rotating electric motor is especially suitable for driving the breaker's operating means. The motor can suitably be a brushless permanent magnetic motor for alternating current, an alternating current motor, a reluctance motor, a synchronous motor, a permanent magnetic commutator motor or any similar type.

A three-phase permanent magnetic alternating current motor is especially suitable for the purpose. This therefore constitutes a preferred embodiment of the electric motor just described.

Since the motor is under-dimensioned it has, according to a preferred embodiment of the invention, a rated torque at the rated load which is 1% to 30% of the torque the power source and the current converter are devised to develop in the motor. With such a degree of under-dimensioning, the cost reduction becomes large enough to be significant, while the overloading is brief enough to prevent any damage to the motor. So this is a preferred embodiment of the invention. The rated torque at the rated load ranges preferably from 3% to 18%.

The lower limit depends on the prevailing application, 2% being a level which may be only used under certain circumstances.

According to another preferred embodiment of the invention, the motor is arranged to operate with a current density in the windings amounting to 15-300 A/mm², preferably 25-200 A/mm². According to yet another preferred embodiment, the motor is arranged to operate with a surface force amounting to 0.03-0.6 N/mm², preferably 0.05-0.6 N/mm². It has been found that a motor in this application can be loaded in the aforementioned ranges for current density and surface force. With loads this great, the motor can be small enough to achieve an efficient and cost-effective circuit breaker.

Since the current converter is under-dimensioned, it has a rated output, according to a preferred embodiment of the invention ranging from 15% to 70% of the output the power source is arranged to deliver to the rectifier. A considerable cost reduction can also be achieved here, and the overload is sufficiently brief to prevent any damage to the rectifier's components by heat release. Here, the rated output is 30% to 55% of the output the current converter is designed to deliver.

Here, ‘rated output’ is defined as the output the rectifier is capable of continuously delivering to the device's motor at the switching rate and DC circuit voltage selected, the difference being that the semiconductors are provided with cooling in the normal way for conventional rectifiers.

According to another preferred embodiment, the power semiconductors of the current converter do not have any cooling flanges or other heat dissipation means. Since the duration of action is so brief, only a small amount of heat develops in the current converter. The cooling flanges or other heat dissipation means normally arranged on a current converter is therefore superfluous. The elimination of cooling flanges reduces the cost of the current converter. This further increases the possibility of making a circuit breaker, according to the invention, competitive in terms of costs compared to conventional technology. In one preferred embodiment of the design without cooling flanges, the current converter contains power semiconductors, which are connected to mounting means, each mounting means only devised to serve as a mounting platform. In this version, the current converter can be incorporated in the simplest way possible, thereby making it cheap and competitive.

However, keeping the heat development, in the current converter under control may be appropriate. According to an additional preferred embodiment, the current converter is therefore equipped with temperature-sensing means. It senses the temperature at one or more points in the current converter at which heat buildup is assumed to be most critical, i.e. the centre point in each bridge. This monitoring makes it possible to utilise overloadability to the greatest possible extent with no risk of damage or malfunction.

The circuit breaker according to the invention is especially suitable for breaking high-voltage current. A circuit breaker devised for such an application is therefore a preferred embodiment of the invention. The circuit breaker's advantages are particularly useful for voltages from 72 to 420 kV.

The aforementioned preferred embodiments of the invented circuit breaker are set forth in the claims dependent on claim 1.

An electric plant, according to the second aspect of the invention, uses for the invented circuit breaker according to the third aspect of the invention and a method for breaking an electric current according to the fourth aspect of the invention are set forth in claims 12, 13-15 and 16 respectively.

The invented electric plant, the invented use and the invented method convey advantages of the kind cited above for the invented electric circuit breaker.

The invention is explained below through detailed descriptions of preferred embodiments of the same with reference to the accompanying drawings.

### BRIEF DESCRIPTION OF THE DRAWINGS

FIG. 1 is a schematic illustration of an electric circuit breaker.

FIG. 2 is a longitudinal section through the operating means of a circuit breaker according to a first embodiment of the invention.

FIG. 3 is a block diagram of a circuit breaker according to the invention.

FIG. 4 illustrates the rectifier in a circuit breaker according to the invention.

FIG. 5 illustrates the principle for cooling a semiconductor in a conventional rectifier.

FIG. 6 illustrates, in the same way as in FIG. 5, the way in which a semiconductor is arranged in a rectifier according to the invention.

FIG. 7 is a diagram of part of switching station according to the invention.

### DESCRIPTION OF PREFERRED EMBODIMENTS

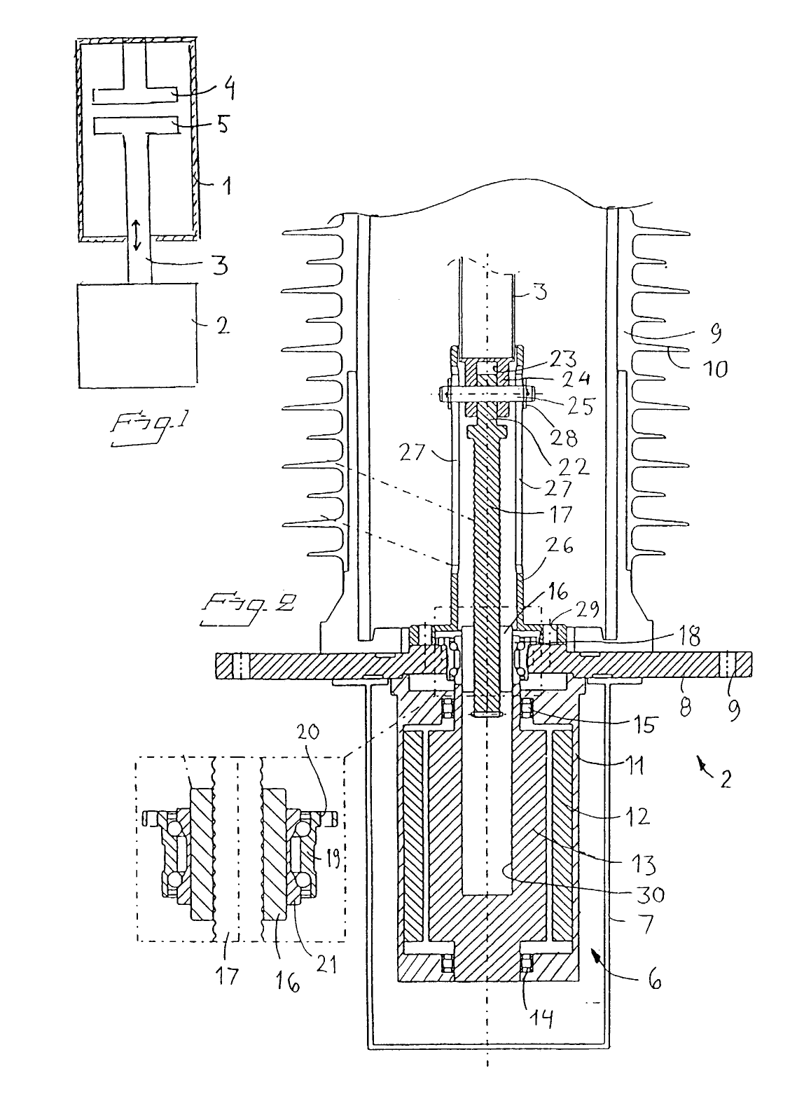

FIG. 1 schematically illustrates the principle of an electric circuit breaker. It consists of a breaker chamber 1, an operating means 2 and an operating rod 3. A stationary contact 4 and a mobile contact 5 are arranged in the breaker chamber. Each of the contacts is electrically connected to a separate line. In normal conditions, the contacts 4, 5 are in contact with one another, and current is conducted from one line to the other line through the circuit breaker. When the current must be broken for some reason, e.g. because of short-circuit currents caused by a fault, the mobile contact 5 is rapidly withdrawn from the stationary contact 4. An arc initially develops between the contacts and is extinguished by a flow of insulating gas shortly after the contacts have separated. When the current is subsequently closed, the mobile contact 5 is again forced into contact with the stationary contact 4. Breaking and closing can be manual or automatic. Turning the circuit breaker ON and OFF is achieved with an operating rod 3 connected to the mobile contact and the driver means in the operating unit. This circuit breaker design is common to all kinds of circuit breakers and can naturally be realised in many different ways. A large number of details, normally found in a circuit breaker, have been omitted from the Fig. This is in order to clarify the operating principle. The description below relates to detail 2 in the Fig., i.e. the operating means. It is illustrated in the Fig. as a unit separate from the breaker chamber, but both these components can, in practice, be incorporated in a single unit.

FIG. 2 illustrates a first embodiment of an operating means 2 for an electric circuit breaker whose structure is similar, in principle, to the structure described in connection with FIG. 1. The operating means 2 contains an electric motor 6 enclosed in a housing 7. One end of the housing is attached to a mounting plate 8 supported in some suitable way by a stand, e.g. with locking bolts through the holes 9 in the plate 8. On the side of the plate turned away from the motor, a hollow pillar 9 of insulating material, e.g. porcelain, extends upward in the Fig. The exterior of the insulation pillar 9 is provided with fins 10 to achieve an extended creep distance. The operating rod 3 is arranged inside the insulation pillar. The breaker chamber is housed in upper end of the insulation pillar (not shown), and its mobile contact is immovably connected to the operating rod 3. The operating rod 3, the insulation pillar 9 and the motor 6 are all coaxially arranged.

A movement-transfer mechanism is arranged for transforming the rotary movement of the motor's rotor 13 into a rectilinear motion for the operating rod 3 in order to break or close the circuit breaker according to the description of FIG. 1. The movement-transfer mechanism will be described below in greater detail.

The motor's rotor 13 in the motor housing 11 is journaled in bearings at each end of the rotor. The motor's stator 12 is attached to the motor housing 11, and the motor housing is attached to the mounting plate 8. The rotor 13 has a central, axial opening 30 extending along most of the rotor's length. The mounting plate 8 has a drilled opening, coaxial to the motor shaft, in which a nut 16 is journaled for rotation in a double-action angular-contact bearing 18. The outer ring 19 of the bearing 18 is attached to the mounting plate 8 with bolts (not shown) arranged in holes 20 through a flange on the outer ring. The inner ring 21 of the bearing 18 is non-rotatingly connected to the nut 16. The inner ring 21 is also non-rotatingly connected to the rotor 13.

A screw 17, i.e. a threaded rod, passes through the nut. The nut 16 and the screw threads 17 engage one another. Their relative mutual rotation thereby causes the screw to move axially in relation to the nut. The end of the screw 17 turned away from the motor, i.e. the upper end in the Fig., is connected to the circuit breaker's operating rod 3, by the upper end of the screw passing through a drilled hole 23 in the lower end of 24 of the operating rod 3. The connection is secured with a diametrically arranged pin 25 which passes through the ends of the screw and operating rod.

A guide sleeve 26 covering the screw 17 extends from the mounting plate 8. The guide sleeve is equipped with diametrically opposed axial guide grooves 27. The pin 25 passes through each guide groove 27 and is equipped at each end with a lock washer 28. The width of the guide groove 27 is the same as the diameter of the pin 25. The screw 17 is accordingly non-rotatingly connected to the guide sleeve 26. The guide sleeve 26 is, in turn, kept from rotating by attachment to the mounting plate 8 with bolts (not shown) through the drilled holes 29. The internal diameter of the guide sleeve 26 is selected to enable the operating rod 3 to slide into it with slight play.

Since the nut 16 is axially affixed by means of its bearing, and the screw 17 is kept from rotating, as just described, a rotary movement of the nut causes the screw to move axially.

FIG. 2 shows the operating section when the circuit breaker is in its normal, closed position.

When the circuit breaker is activated to break the current, the motor 6 starts, and its rotor 13 rotates clockwise, as seen from above in the Fig. This forces the screw to move downward, and the mobile contact 5 (see FIG. 1) withdraws from contact with the fixed contact. The length of the centre hole 30 provides space for the screw to move far enough to achieve complete breaking. During the breaking operation, the lower part of the operating rod 3 slides down into the guide sleeve 26.

The motor stops when breaking is completed. In this position, the lower end of the screw 17 is near the bottom of the drilled hole 30. The pin 25 is then located at the bottom end of the guide groove 27. When the circuit breaker is subsequently reset, the motor starts, rotating in the opposite direction, whereupon the screw 17 and, accordingly, the operating rod rise until the mobile contact 5 resumes contact with the stationary contact. The device's parts then assume the position shown in FIG. 2.

The operating means' transformation of the motor's rotary movement into rectilinear movement can naturally be performed in many other ways than the one described in connection with FIG. 2. In addition, motion transformation is not always necessary. Within the scope of the invention, the mobile contact could also perform a rotary movement, at ON-OFF operation or alternatively even a rectilinear movement driven by a linear motor. In the version described in FIG. 2, the nut is. In the version taught in FIG. 2, the nut is connected to the rotor and the screw to the mobile contact. In certain instances, the reverse may be preferable, i.e. the screw is connected to the rotor and the nut to the mobile contact. Thus, the screw would rotate with the rotor, and the nut would be forced to assume rectilinear movement because of its attachment to the screw. This version conveys the advantage that a much smaller mass is accelerated in performing rectilinear movement than in the version shown in FIG. 2. The nut has much less mass than the screw.

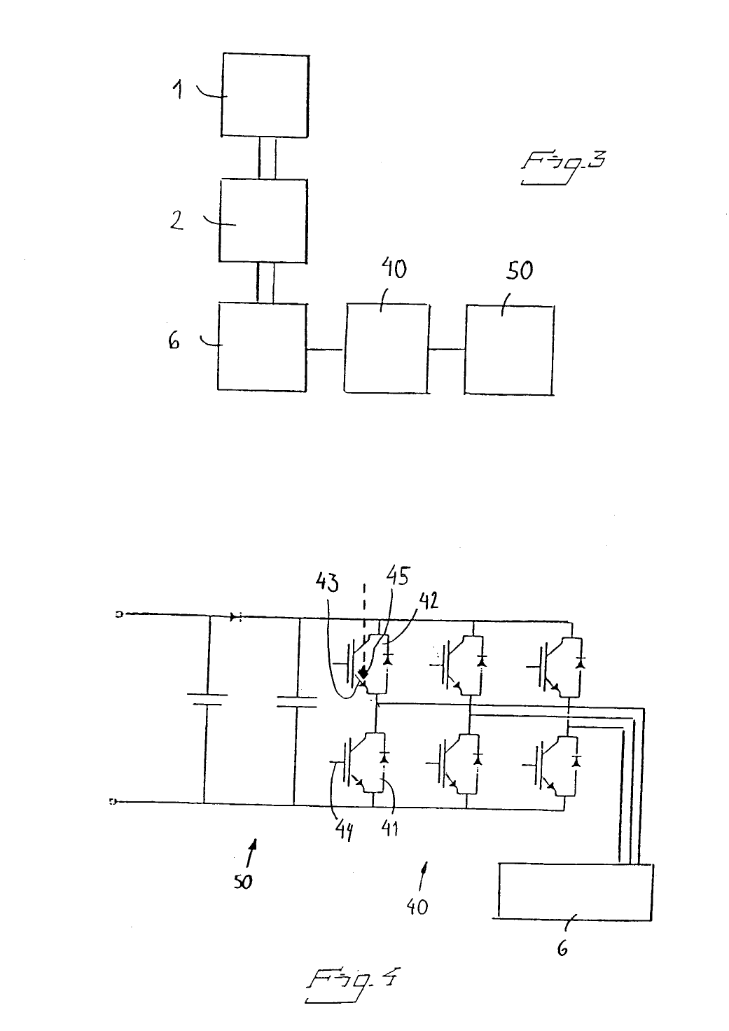

FIG. 3 is a block diagram showing the interaction of the different components in a circuit breaker according to the invention.

The block diagram shows the circuit breaker's breaker chamber 1 mechanically connected to the operating means 2. The latter is driven by the motor 6 which could be e.g. a three-phase permanent magnetic alternating current motor. The motor receives its power from a power source 50 such as batteries, capacitors, the mains or a combination thereof. A current converter 40 is arranged between the motor 6 and the source of power 50. It will be described below. For the sake of clarity, the control system and other requisite equipment are not included in the Fig.

When the circuit breaker is to be activated for breaking, which can be manual or automatic, because of a short-circuit in the system in which the circuit breaker is incorporated, the current is closed between the motor 6 and the source of power 50, causing the motor 6 to start rotating. Breaking time is about 40-60 ms. During that time, the motor must impart powerful torque to the operating means 2 so the mobile contact is quickly withdrawn from the stationary contact. The motor must therefore develop a high output for a brief period of time. The motor 6 is dimensioned for heavy overloading during this time. The overload for a circuit breaker intended for a 145 kV line is up to 15 times its rated data with respect to delivered torque. The overload should be at least 4 times greater. The weight of the motor can thereby be kept to 25-50 kg. The overload is about 20-30 times greater for a circuit breaker intended for 420 kV. A maximal current density of about 5-10 A/mm² is permissible in the windings of a conventional motor in order to prevent heat-induced damage. With the motor in a circuit breaker according to the invention, a current density on the order of 25-300 A/mm² is permissible with no risk of damage. This is because only a small amount of heat has time to develop during the brief, period of activity. The motor's surface force can then amount to about one to two powers of ten more than the normal value of 0.01 N/mm² for conventional motors.

FIG. 4 illustrates a current converter 40 suitable for use with a circuit breaker of the kind shown in FIGS. 1-3. The current converter is devised as an inverter, which converts the direct current of the power source 50 into alternating current for the motor 6. The inverter is arranged for three-phase and therefore encompasses three bridges. Each phase bridge is an IGBT (insulated-gate bipolar transistor) type with anti-parallel diodes in series in a positive 41 and a negative 42 bridge half. Each bridge half is controlled by a control 44 connected to a control unit (not shown), and each bridge's centre point 43 is connected to the motor 6. The current converter operates with pulse width modulation (PWM).

Factors governing the load the semiconductors of the current converter can tolerate are the electric field they can tolerate, a factor governing the maximal permissible voltage in the DC circuit, and the temperature at the semiconductor junction 43, a factor affecting the maximal permissible power loss of the current converter.

The current converter can be overloaded mainly with respect to permissible power loss. The loss develops in transistors and diodes at each ON and OFF operation. The higher the PWM frequency, the greater the switching losses. Energy is transformed into heat when power losses develop in semiconductors. The heat is generated at each semiconductor junction 43 and passed on to the surroundings through the silicon and base plate of the current converter. Power losses increase with the DC circuit's voltage and the motor's amperage. Since the maximal permissible voltage may not be exceeded, the motor's amperage is the main increasable parameter.

Thus, amperage from the semiconductors is allowed to exceed the maximal value caused by the temperature rise during continuous operation. The brief period of activity of less than 100 ms allows additional power loss without exceeding the maximal permissible temperature at the semiconductor junction. The current converter can accordingly supply more kVA than the rated value. If the highest permissible temperature in the semiconductor junction is about 125° and the ambient temperature is about 70° C., the amperage supplied for a 145 kV circuit breaker can be increased to 400 A instead of the rated 150 A. This is achieved with a temperature rise at the semiconductor junction of no more than 40° C. In the corresponding fashion, the amperage for a 420 kV circuit breaker can be increased to 3×750 A instead of normally 3×400 A.

A temperature-sensor 45 is arranged at each semiconductor junction 43 to provide control over heat released in the semiconductor junctions. Information on the temperature at a semiconductor junction 43 is sent to a control unit (not shown).

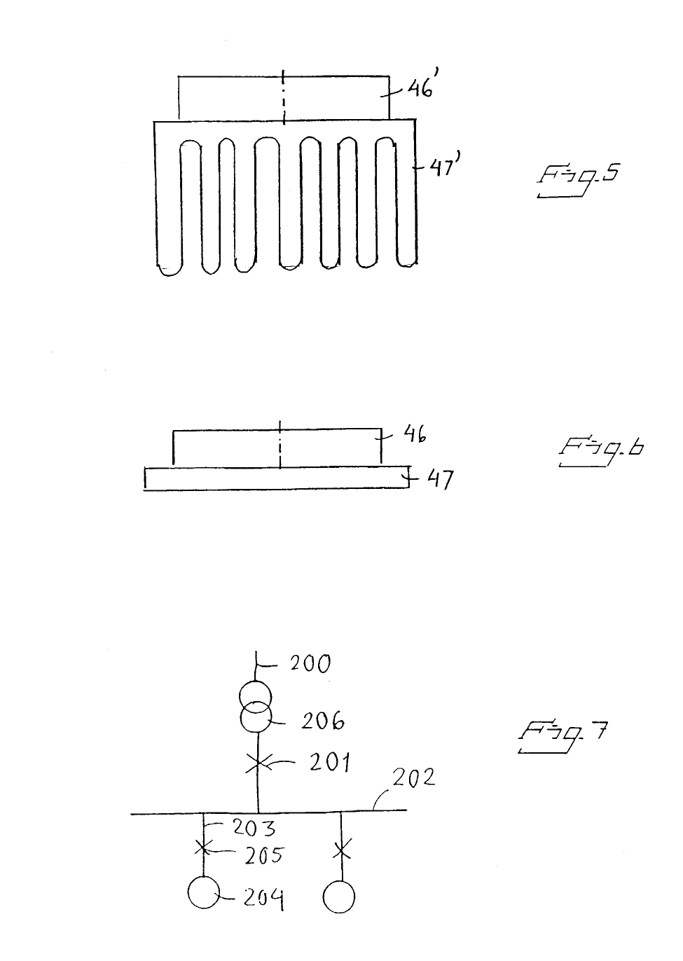

A power semiconductor normally requires some form of cooling device. FIG. 5 depicts the principle for the way in which a conventional semiconductor component 46′ is mounted on a cooler 47′ with cooling flanges for air cooling. Circulating water is conventionally used as an alternative way of removing heat.

In the current converter according to the invention, the power semiconductors do not employ any cooler. The component can therefore be arranged on a base plate without any heat sink. The sole purpose of the base plate is to serve as a mounting for the component. This is illustrated, in principle, in FIG. 6. Here, the semiconductor 46 is mounted on a base plate 47, which only serves as a means for mounting the semiconductor 46 in the current converter. As previously noted, the Fig. only depicts the principle. The mounting means can naturally have different design within the scope of its function solely as a mount for the semiconductor in the current converter.

The invented circuit breaker can be used for single-pole as well as triple-pole breaking. The motor's power can be supplied by a bank of capacitors, a battery or the mains.

FIG. 7 shows an electric facility encompassing part of an electric switching station. An input line 200 is connected, via a transformer 206 and a first breaker 201, to a bus-bar 202. An output line 203 from same goes to the respective load 204 via a respective circuit breaker 204. Each of the circuit breakers 201 and 205 is devised in accordance with the circuit breaker in the present invention.

1. An electric circuit breaker comprising at least one mobile contact (5), means (2) for operating the mobile contact (5), a rotating electric motor (6) for driving the operating means (2), a current source arranged for brief connection to the motor (6) and a current converter (40) arranged between the motor (6) and the current source (50), said current source being arranged for brief delivery of sufficient power for operating the mobile contact is a short period of time, characterized in that at least one of the motors (6) and the current converter (40) have a much lower rated output than the power the current source (50) is devised to deliver.

2. An electric circuit breaker according to claim 1, characterized in that the rotating electric motor (6) is a synchronous, permanent magnetic, alternating current motor.

3. An electric circuit breaker according to claim 1 or 2, characterized in that the motor (6) has a rated torque which is 1% to 30%, preferably 3% to 18%, of the torque the current source (50) and current converter (40) are devised to develop in the motor (6).

4. An electric circuit breaker according to claim 1 or 2, characterized in that the motor (6) is arranged to operate with a current density amounting to 15-300 A/mm², preferably 25 to 200 A/mm².

5. An electric circuit breaker according to any of claims 1-3, characterized in that the motor (6) is arranged to operate with a surface force amounting to 0.03 to 0.6 N/mm², preferably 0.05 to 0.6 N/mm².

6. An electric circuit breaker according to any of claims 1-5, characterized in that the current converter (40) has a nominal rated output which is 15% to 70%, preferably 30% to 55%, of the output the current converter (40) is devised to deliver.

7. An electric circuit breaker according to any of claims 1-6, characterized in that the current converter (40) is equipped with power semiconductors (406) without any cooling means.

8. An electric circuit breaker according to claim 7, characterized in that the current converter (40) is equipped with power semiconductors (46) which are mechanically connected only to the mounting means (47), the mounting means (47) being devised in a manner solely dictated by its mounting function.

9. An electric circuit breaker according to any of claims 1-8, characterized in that the current converter (40) is equipped with a temperature-sensing means (45) arranged to sense the temperature at least some point in the current converter, preferable at a semiconductor junction (43).

10. An electric circuit breaker according to any of claims 1-9, characterized in that the circuit breaker is arranged to break electric current in the high-voltage range, preferably in the 72 to 420 kV range.

11. An electric plant comprising at least one circuit breaker (201, 205), characterized in that at least one of the electric circuit breakers (201, 205) is of the kind set forth in any of claims 1-10.

12. The use of an electric circuit breaker, according to any of claims 1-10, for breaking an electric current.

13. The use of an electric circuit breaker, according to any of claims 1-10, for breaking the electric current in a transmission network.

14. The use of an electric circuit breaker, according to any of claims 1-10, for breaking the electric current in a distribution network.

15. A method for breaking an electric current in which a mobile contact's contact with a second contact is broken by an operating means, said operating means being driven by an electric motor, whereby the electric motor is connected during breaking to a current source by a current converter, said current source being arranged for brief delivery of an output sufficient for operating the mobile contact in a short period of time, characterized in that at least one of the motor and the current converter is subjected to a heavy electric overload.

16. A method according to claim 15, characterized in that the current converter is overloaded with power 1.5 to 5, preferably 2 to 3, times its nominal rated output.

17. A method according to claim 15 or 16, characterized in that the motor is a rotating electric motor devised to develop torque 4 to 50, preferably 7.5 to 35, times its nominal rated torque.

18. A method according to any of claims 15-17, characterized in that a current density amounting to 15-300, preferably 25-200, A/mm² is imposed on the motor windings.

19. A method according to any of claims 15-18, characterized in that the motor is devised to develop a surface force amounting to 0.03-0.6 N/mm², preferably 0.05-0.6 N/mm².

20. A method according to any of claims 15-19, characterized in that the method is performed during utilisation of an electric circuit breaker of the kind set forth in any of claims 1-10.
